(19) United States
(12) Patent Application Publication
(10) Pub. No.: US 2025/0128205 A1
(43) Pub. Date: Apr. 24, 2025

(54) TECHNIQUES FOR DIRECT-AIR CAPTURE OF CARBON USING SEAWATER

(71) Applicant: Varin SIKKA, Los Altos Hills, CA (US)

(72) Inventor: Varin SIKKA, Los Altos Hills, CA (US)

(21) Appl. No.: 18/923,466

(22) Filed: Oct. 22, 2024

Related U.S. Application Data
(60) Provisional application No. 63/592,531, filed on Oct. 23, 2023.

(51) Int. Cl. B01D 53/62; B01D 53/14; B01D 53/18; B01D 53/78; C01D 1/04; C25B 1/20

(52) U.S. Cl. CPC B01D 53/62; B01D 53/1475; B01D 53/1493; B01D 53/18; B01D 53/78; C01D 1/04; B01D 2251/304; B01D 2251/604; B01D 2257/504; B01D 2258/06; C25B 1/20

(57) ABSTRACT

According to various embodiments, a carbon capture system includes: a renewable power source; an electrolysis chamber that generates chlorine (CI), hydrogen (H), and an aqueous sodium hydroxide (NaOH) solution from a sodium chloride (NaCl) solution using electrical energy from the renewable power source; a mixing chamber that generates an aqueous sodium bicarbonate (NaHCO₃) solution by mixing CO₂-containing air and the aqueous NaOH solution; and a CO₂ extraction chamber that generates CO₂ by combining the aqueous NaHCO₃ solution with hydrogen chloride (HCl).

### CROSS-REFERENCE TO RELATED APPLICATIONS

This application claims priority benefit of the United States Provisional Patent Application titled, “ADDITIONAL TECHNIQUES FOR LOW-POWER, LARGE SCALE DIRECT AIR CAPTURE” filed on Oct. 23, 2023 and having Ser. No. 63/592,531. The subject matter of this related application is hereby incorporated herein by reference.

### FIELD OF THE VARIOUS EMBODIMENTS

The various embodiments relate generally to carbon capture technology and, more specifically, to a system for direct-air capture of carbon using seawater.

### DESCRIPTION OF THE RELATED ART

According to many scientific studies, global warming is becoming a serious problem for both current and future generations. Many argue that a primary contributor to global warming is the human expansion of the “greenhouse effect,” in which the Earth's atmosphere traps heat that would otherwise radiate from the Earth into space. The different gases contributing to the greenhouse effect (referred to herein as “greenhouse gases”) include water vapor, methane, nitrous oxide, and carbon dioxide. Many scientists believe that the most serious effects of global warming can be prevented by reducing human-based emissions of greenhouse gases and lowering the concentration of greenhouse gases currently in the Earth's atmosphere. To that end, one technology being developed to address global warming is direct-air carbon capture, where carbon dioxide is captured and removed from the Earth's atmosphere.

Direct-air carbon capture typically involves attempts to remove large quantities of carbon dioxide from the Earth's atmosphere by an adsorption/desorption process. In many direct-air carbon capture implementations, ambient air is exposed to a suitable sorbent, such as an amine-based material, which then adsorbs the carbon dioxide present in the ambient air. The adsorbed carbon dioxide is subsequently released from the sorbent via a desorption process for subsequent storage.

For direct-air carbon capture or any other process to be a viable approach for reducing the greenhouse effect, the process of removing carbon dioxide from the Earth's atmosphere needs to result in negative greenhouse gas emissions. That is, the amount of greenhouse gas produced when generating the energy necessary to effect the direct-air carbon capture process has to be less than the amount of greenhouse gas the direct-air carbon process removes from the Earth's atmosphere.

One drawback to conventional direct-air carbon capture processes is that those processes typically require significant amounts of energy, including the thermal energy required to free carbon dioxide in the desorption process and, oftentimes, the fan energy required to direct ambient air onto the sorbent material. Accordingly, in order to achieve a negative greenhouse gas emission process, conventional direct-air carbon capture facilities are typically located at or near large sources of renewable energy, such as the site of a geothermal reservoir, a solar power plant, or a wind farm. Such location constraints prevent direct-air carbon capture processes from being broadly implemented, which limits the effectiveness of direct-air carbon capture in combating global warming. Another drawback to conventional direct-air carbon capture processes is that suitable sorbent materials are not readily available in the large quantities needed to remove the millions of tons of carbon dioxide generated per year from the atmosphere.

As the foregoing illustrates, what is needed in the art are more effective techniques for direct-air carbon capture.

### SUMMARY

According to various embodiments, a carbon capture system includes: a renewable power source; an electrolysis chamber that generates chlorine (CI), hydrogen (H), and an aqueous sodium hydroxide (NaOH) solution from a sodium chloride (NaCl) solution using electrical energy from the renewable power source; a mixing chamber that generates an aqueous sodium bicarbonate (NaHCO₃) solution by mixing CO₂-containing air and the aqueous NaOH solution; and a CO₂ extraction chamber that generates CO₂ by combining the aqueous NaHCO₃ solution with hydrogen chloride (HCl).

At least one technical advantage of the disclosed design relative to the prior art is that the disclosed design enables direct-air carbon capture without needing conventional sorbent materials, such as an amine-based material. Instead, a sodium hydroxide (NaOH) solution is generated electrolytically from seawater and is subsequently used to chemically react with CO₂ in the air. Another technical advantage is that any renewable energy source can be employed to power the direct-air carbon capture process implemented using the disclosed design. A further technical advantage is that fan energy is not required for the direct-air carbon capture process implemented using the disclosed design, which enables the process to be greenhouse gas net-negative. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a direct-air carbon capture system configured to implement one or more aspects of the various embodiments.

FIG. 2 is a more detailed illustration of the direct-air carbon capture system of FIG. 1, according to various embodiments.

FIG. 3 is a more detailed illustration of an electrolysis chamber of the direct-air carbon capture system of FIG. 1, according to various embodiments.

FIG. 4 sets forth a flowchart of method steps for direct-air carbon capture, according to various embodiments.

For clarity, identical reference numbers have been used, where applicable, to designate identical elements that are common between figures. It is contemplated that features of one embodiment may be incorporated in other embodiments without further recitation.

### DETAILED DESCRIPTION

In the following description, numerous specific details are set forth to provide a more thorough understanding of the various embodiments. However, it will be apparent to one of skill in the art that the inventive concepts may be practiced without one or more of these specific details.

### INTRODUCTION

According to various embodiments, a direct-air carbon capture system enables the collection of CO₂ from ambient air using electricity and seawater. The system performs a low-energy direct-air carbon capture process that is powered using electrical energy generated by a renewable energy source. In particular, an electrolysis chamber of the system generates hydrogen (H), chlorine (CI), and an aqueous solution of sodium hydroxide (NaOH) via a modified chloralkali process, which is an industrial process for the electrolysis of sodium chloride (NaCl) solutions. A mixing chamber of the system then generates sodium bicarbonate (NaHCO₃) by capturing CO₂ from air that is mixed with the aqueous solution of NaOH. In a CO₂ extraction chamber of the system, the carbon that is captured within the NaHCO₃ is released as CO₂ and stored when the NaHCO₃ is mixed with HCl (either in gaseous form or as an aqueous solution). Because no exotic sorbent is required in the above-described process, and because renewable energy can be used to power the electrolysis chamber, the direct-air carbon capture system described herein is highly scalable and energy efficient.

### System Overview

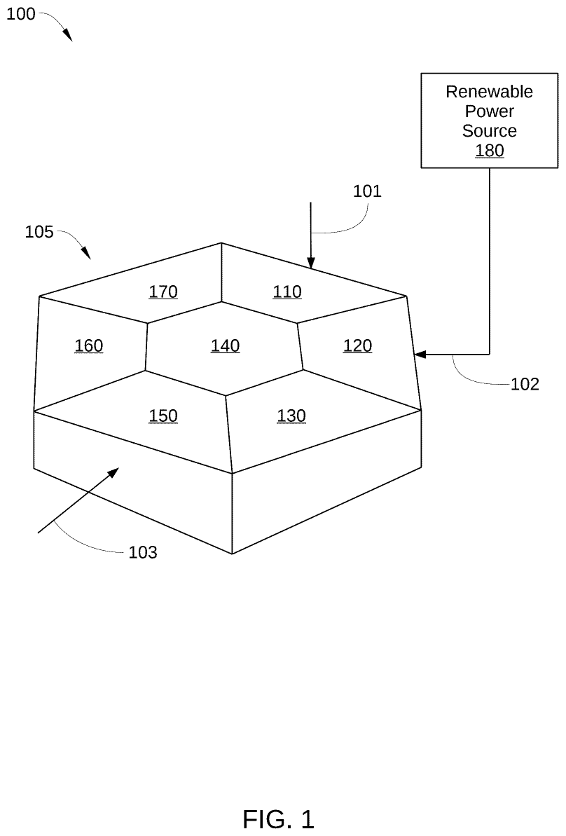

FIG. 1 is a conceptual illustration of a direct-air carbon capture system 100 configured to implement one or more aspects of the various embodiments. Direct-air carbon capture system 100 removes carbon dioxide (CO₂) from ambient air via a direct-air carbon capture process that is powered using electrical energy 102 generated by a renewable power source 180. Because the herein-described direct-air carbon capture process removes CO₂ from ambient air using multiple chemical reactions, no sorbent material is required. Further, in some embodiments, little or no fan energy is expended as part of the direct-air carbon capture process, thereby increasing the total negative greenhouse gas emissions of the process. As shown, direct-air carbon capture system 100 includes a renewable power source 180 that generates electrical energy 102, and a carbon extractor 105.

Renewable power source 180 can include any combination of one or more non-fossil-fuel burning energy sources, such as wind turbine(s), hydropower plant(s), geothermal power plant(s), and/or batteries charged via wind power, hydropower, or geothermal power. Alternatively or additionally, in some embodiments, renewable power source 180 includes power from an idle wind turbine or solar array that is not currently providing power to a power grid even though energy-generating capability is available.

Alternatively or additionally, in some embodiments, renewable power source 180 includes one or more pumped storage hydropower units. Such energy storage systems can include a dual pump/turbine and one or more water towers, where the water tower is charged with water via the pump during high availability of solar or wind power. Conversely, when power is required by direct-air carbon capture system 100 during a time of low or non-existent availability of solar or wind power, water is released from the tower and electrical power is generated via the turbine.

In the embodiment illustrated in FIG. 1, carbon extractor 105 includes a receiving chamber 110, an electrolysis chamber 120, a first holding chamber 140, a second holding chamber 130, a mixing chamber 150, a CO₂ extraction chamber 160, and a CO₂ storage chamber 170. In operation, carbon extractor 105 receives prepared seawater 202 and ambient air 103 (which contains CO₂) and extracts the CO₂ contained in 103 ambient air via a modified chloralkali process, which is described in greater detail below. Carbon extractor 105 is powered using electrical energy 102 generated by a renewable power source 180. According to various embodiments, in addition to the CO₂ extracted from 103 ambient air, the modified chloralkali process only produces water (H₂O) and sodium chloride (NaCl). The various chambers of carbon extractor 105 are described in greater detail below.

### Electrolysis-Based Carbon Extraction System

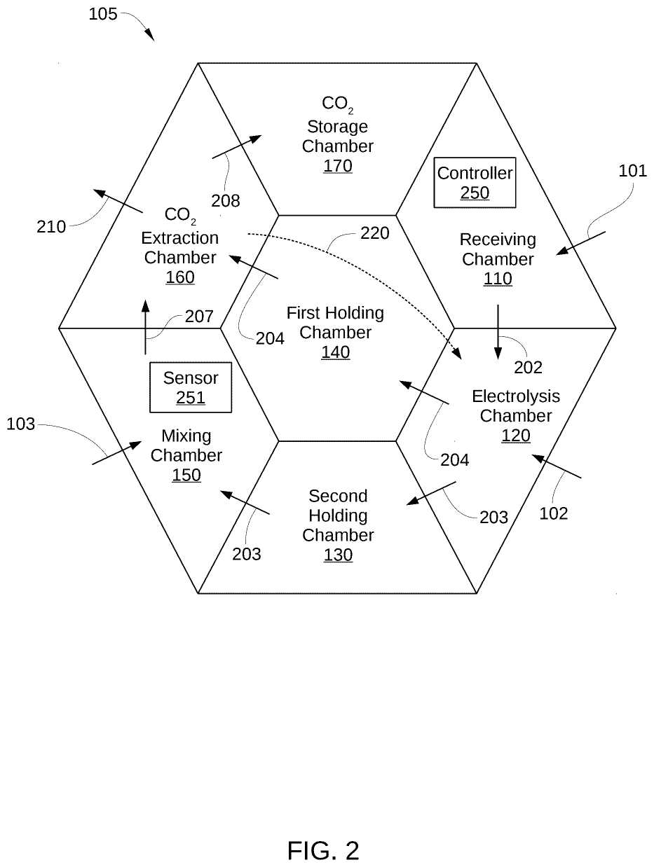

FIG. 2 is a more detailed illustration of direct-air carbon capture system 100 of FIG. 1, according to various embodiments. As shown, carbon extractor 105 includes receiving chamber 110, electrolysis chamber 120, first holding chamber 140, second holding chamber 130, mixing chamber 150, CO₂ extraction chamber 160, and/or CO₂ storage chamber 170. In the embodiment illustrated in FIG. 2, carbon extractor 105 is implemented in a hexagonal configuration, with multiple chambers of carbon extractor 105 positioned adjacent to other chambers of carbon extractor 105. In other embodiments, the chambers of carbon extractor 105 can be arranged in any suitable configuration, for example in a linear array, a circular array, a rectangular grid array, and/or the like.

As shown, receiving chamber 110 generates prepared seawater 202 and transmits prepared seawater 202 to electrolysis chamber 120. Electrolysis chamber 120 generates hydrogen chloride (HCl) 204, which is transmitted to first holding chamber 140, and a NaOH solution 203, which is transmitted to second holding chamber 130. First holding chamber 140 transmits HCl 204 to CO₂ extraction chamber 160 and second holding chamber 130 transmits aqueous NaOH solution 203 to mixing chamber 150. Mixing chamber 150 generates NaHCO₃207 and transmits the NaHCO₃ to CO₂ extraction chamber 160. CO₂ extraction chamber 160 generates CO₂ (gas) 208, NaCl 210, and byproduct water 220.

Receiving chamber 110 receives seawater 101 and prepares seawater 101 for an electrolysis process, for example by filtering particulate contamination from the seawater. Receiving chamber 110 is fluidly coupled to electrolysis chamber 120, and transmits prepared seawater 202 to electrolysis chamber 120. In some embodiments, receiving chamber 110 includes a suitable system for receiving, preparing, and transmitting seawater. In such embodiments, receiving chamber may include pipes, pumps, fluid-level sensors, filters, and/or the like.

Additionally or alternatively, in some embodiments, receiving chamber 110 includes a controller 250. Controller 250 is configured to control operation of carbon extractor 105, and may be any technically feasible hardware unit capable of processing data and/or executing instructions associated with the operation of carbon capture extractor 105. In operation, controller 250 controls operation of the various chambers of carbon extractor 105, including pumps, valves, sensors, electrolytic cells, and/or the like. In some embodiments, controller 250 receives inputs from one or more sensors and/or control valves associated with various chambers of carbon extractor 105.

Controller 250 can be implemented as any suitable processor or computing device, such as a central processing unit (CPU), a graphics processing unit (GPU), an application-specific integrated circuit (ASIC), a field programmable gate array (FPGA), any other type of processing unit, or a combination of different processing units, such as a CPU configured to operate in conjunction with a GPU or digital signal processor (DSP). In some embodiments, controller 250 is implemented as one or more integrated circuits or chips included in carbon extractor 105. Alternatively, in some embodiments, controller 250 is implemented as a computing device, such as a desktop computer, laptop computer, mobile phone, electronic tablet, and/or the like.

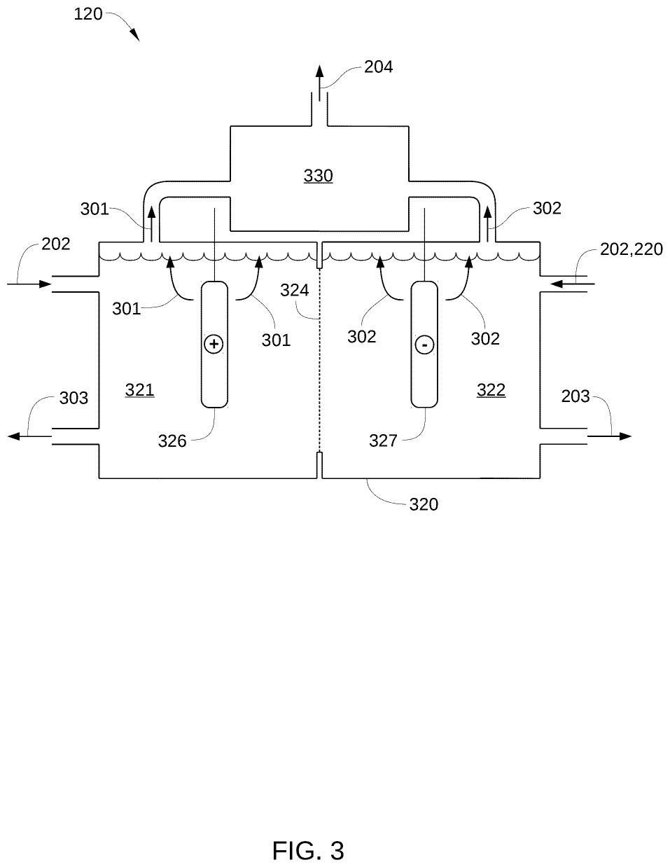

Electrolysis chamber 120 performs a modified chloralkali process that generates CI, H, and a NaOH solution from seawater, which is primarily a NaCl solution. Electrolysis chamber 120 uses electrical energy from renewable power source 180. One embodiment of electrolysis chamber 120 is described below in conjunction with FIG. 3.

FIG. 3 is a more detailed illustration of electrolysis chamber 120, according to various embodiments. In the embodiment illustrated in FIG. 3 electrolysis chamber 120 is implemented as a membrane cell 320 and includes an anode 326 in an anodic region 321 and a cathode 327 in a cathodic region 322. As shown, anodic region 321 is separated from anodic region 321 via an ion-selective membrane 324 that prevents reaction between chloride (Cl⁻) and hydroxide (OH⁻) ions. In some embodiments, ion-selective membrane 324 includes a material that allows counterions, in this case sodium (Na⁺), to freely flow thereacross, but prevents anions, in this case OH⁻ and Cl⁻, from diffusing thereacross. In some embodiments, ion-selective membrane 324 is made from Nafion, Flemion, or Aciplex.

In operation, anodic region 321 is charged with prepared seawater 202 and cathodic region 322 is charged with prepared seawater 202 and/or byproduct water 220 from CO₂ extraction chamber 160. Voltage is then applied across anode 326 and cathode 327, causing Cl⁻ to be oxidized to chlorine at anode 326, which can evolve as chlorine gas (Cl₂) 301 and exits membrane cell 320 as shown. Further, at cathode 327, water is reduced to OH⁻ and hydrogen gas (H₂) 302, the latter of which can evolve at cathode 322 and exits membrane cell 320 as shown. Ion-selective membrane 324 allows Na⁺ to freely flow from anodic region 321 to cathodic region 322 and prevents OH⁻ and Cl⁻ from diffusing from cathodic region 322 to anodic region 321. As a result, the net process is the electrolysis of an aqueous solution of NaCl (such as prepared seawater 202) into aqueous NaOH solution 203, chlorine gas (Cl₂) 301, and hydrogen gas (H₂) 302.

In some embodiments, electrolysis chamber 120 further includes a combination chamber 330 for combining chlorine gas (Cl₂) 301 and hydrogen gas (H₂) 302 to form HCl 204. In some embodiments, HCl 204 is formed as a gas and is transmitted to first holding chamber 140 as shown in FIG. 2. In other embodiments, HCl 204 is formed as an aqueous solution and is transmitted to first holding chamber 140 as shown in FIG. 2.

In some embodiments, the above processes are performed in a continuous mode, in which prepared seawater 202 is continuously fed into anodic region 321, prepared seawater 202 and/or byproduct seawater 220 is fed into cathodic region 322, and aqueous NaOH solution 203 continuously flows out of cathodic region 322. In other embodiments, the above processes are performed in a batch mode, in which the electrolytic process is performed until a target concentration of NaOH in cathodic region 322 is reached, at which point, aqueous NaOH solution 203 is drained from cathodic region 322 and membrane cell 320 is recharged.

Returning to FIG. 2, first holding chamber 140 receives and stores HCl 204, for example as a gas or as an aqueous solution. When mixing chamber 150 requires additional HCl 204, first holding chamber 140 transmits a suitable quantity of HCl 204 to mixing chamber 150. Generally, first holding chamber 140 includes materials compatible for contact with aqueous HCl 204, which can be highly acidic. For example, in some embodiments, first holding chamber 140 includes a fiberglass-reinforced plastic (FRP) interior, a polyethylene interior, and/or a stainless steel interior with a natural-rubber lining. Furthermore, in some embodiments, first holding chamber 140 includes a suitable control system for monitoring and regulating incoming and outgoing flows.

Second holding chamber 130 receives and stores aqueous NaOH solution 203. When mixing chamber 150 requires additional aqueous NaOH solution 203, second holding chamber 130 transmits a suitable quantity of aqueous NaOH solution 203 to mixing chamber 150. Generally, second holding chamber 130 includes materials compatible for contact with aqueous NaOH solution 203, which can be relatively caustic. For example, in some embodiments, first holding chamber 140 includes a stainless steel interior and/or a natural rubber lining. Furthermore, in some embodiments, first holding chamber 140 includes a suitable control system for monitoring and regulating incoming and outgoing flows.

Mixing chamber 150 generates NaHCO₃207 (for example as an aqueous solution) by combining CO₂-containing air (such as ambient air 103) and aqueous NaOH solution 203 received from second holding chamber 130. In some embodiments, ambient air is bubbled through or otherwise mixed with aqueous NaOH solution 203. In some embodiments, mixing chamber 150 includes temporary storage for NaHCO₃207, such as a tank for storing an aqueous solution of NaHCO₃.

In some embodiments, the flow of ambient air 103 and/or the flow of aqueous NaOH solution 203 is regulated based on detection of sodium carbonate (Na₂CO₃). In such embodiments, mixing chamber 150 modifies the mixing process upon detection of Na₂CO₃ being generated. In this way, little or no Na₂CO₃ is generated by mixing chamber 150, thereby enhancing the overall efficiency of carbon extractor 105. In such embodiments, mixing chamber 150 includes a sensor 251 for detecting NaHCO₃ in the aqueous Na₂CO₃ solution207 disposed within mixing chamber 150.

CO₂ extraction chamber 160 generates CO₂ (gas) 208 by combining an aqueous NaHCO₃ solution 207 (received from mixing chamber 150) with HCl 204 (received from first holding chamber 140). For example, in some embodiments, NaHCO₃ solution 207 is mixed with an aqueous solution of HCl 204. In other embodiments, HCl (gas) is bubbled through or otherwise mixed with NaHCO₃ solution 207. CO₂ gas 208 that is generated by CO₂ extraction chamber 160 is captured and transmitted to CO₂ storage chamber 170.

In addition to CO₂ gas 208, the combination of aqueous NaHCO₃ solution 207 with an HCl 204 further generates an NaCl 210 and byproduct water 220. In some embodiments, CO₂ extraction chamber 160 generates an NaCl solution that is the combination of NaCl 210 and byproduct water 220. In other embodiments, CO₂ extraction chamber 160 generates NaCl and byproduct water 220 separately.

CO₂ storage chamber 170 stores CO₂ gas 208. In some embodiments, CO₂ gas 208 is stored in a different phase, for example as dry ice. In other embodiments, CO₂ gas 208 is mineralized or otherwise stored.

### Example Embodiment of Direct-Air Capture Process Using Seawater

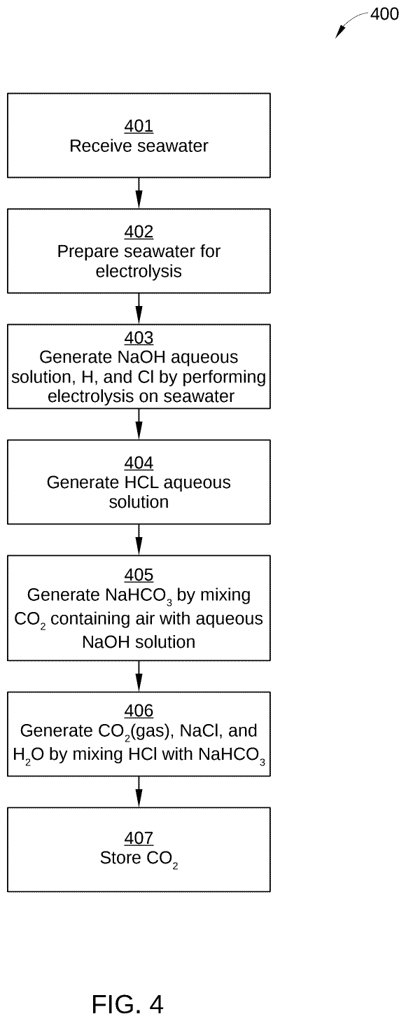

FIG. 4 sets forth a flowchart of method steps for direct-air carbon capture, according to various embodiments. Although the method steps are described with respect to direct-air carbon capture system 100 of FIGS. 1-3, any system configured to implement the method steps, in any order, falls within the scope of the various embodiments. Further, although the method steps are illustrated in a particular order, the method steps may be performed in parallel, and/or in a different order than those described herein. Also, the various method steps may be combined into fewer blocks, divided into additional blocks, and/or eliminated based upon a particular implementation.

As shown, a method 400 begins at step 401, where controller 250 causes seawater 101 to be received by receiving chamber 110. In step 402, receiving chamber 110 generates prepared seawater 202 by filtering or otherwise preparing seawater 101 for an electrolysis process. Prepared seawater 202 is then transmitted to electrolysis chamber 120.

In step 403, electrolysis chamber 120 generates CI, H, and aqueous NaOH solution 203 from the NaCl solution included in prepared seawater 202. Electrical energy from renewable power source 180 is employed to power electrolysis chamber 120.

In step 404, an HCl is formed from the H and CI generated in step 403 by electrolysis chamber 120. In some embodiments, an aqueous solution of HCl is formed; in other embodiments, HCl is in gaseous form.

In step 405, mixing chamber 150 generates NaHCO₃207 (for example as an aqueous solution) by combining ambient air 103 and aqueous NaOH solution 203 received from second holding chamber 130. In some embodiments, ambient air is bubbled through or otherwise mixed with aqueous NaOH solution 203.

In step 406, CO₂ extraction chamber 160 generates CO₂ (gas) 208 by combining an aqueous NaHCO₃ solution 207 with HCl 204. In addition to CO₂ gas 208, the combination of aqueous NaHCO₃ solution 207 with an HCl 204 further generates an NaCl 210 and byproduct water 220.

In step 407, CO₂ storage chamber 170 stores CO₂ gas 208. In some embodiments, CO₂ gas 208 is stored in a different phase, for example as dry ice. In other embodiments, CO₂ gas 208 is mineralized or otherwise stored.

In sum, the various embodiments shown and provided herein set forth techniques that enable the collection of CO₂ from ambient air using electricity and seawater. A direct-air carbon capture system performs a low-energy direct-air carbon capture process that is powered using electrical energy generated by a renewable energy source. In particular, an electrolysis chamber of the system generates an aqueous solution of NaOH, H, and CI via a modified chloralkali process. A mixing chamber of the system then generates NaHCO₃ by capturing CO₂ from air that is mixed with the aqueous solution of NaOH. In a CO₂ extraction chamber, the carbon that is captured within the NaHCO₃ is released as CO₂ gas and stored when the NaHCO₃ is mixed with HCl (either in gaseous form or as an aqueous solution).

At least one technical advantage of the disclosed design relative to the prior art is that the disclosed design enables direct-air carbon capture without needing a conventional sorbent material, such as an amine-based material. Instead, a sodium hydroxide (NaOH) solution is generated electrolytically from seawater, and is used to chemically react with CO₂ in air. Another technical advantage of the disclosed design is that any renewable energy source can be employed to power the herein-described direct-air carbon capture process. A further technical advantage of the disclosed design is that fan energy is not required for the herein-described direct-air carbon capture process, which enables the process to be greenhouse gas net-negative. These technical advantages provide one or more technological advancements over prior art approaches.
1. In some embodiments, a carbon capture system, includes: a renewable power source; an electrolysis chamber that generates chlorine (CI), hydrogen (H), and an aqueous sodium hydroxide (NaOH) solution from a sodium chloride (NaCl) solution using electrical energy from the renewable power source; a mixing chamber that generates an aqueous sodium bicarbonate (NaHCO₃) solution by mixing CO₂-containing air and the aqueous NaOH solution; and a CO₂ extraction chamber that generates CO₂ by combining the aqueous NaHCO₃ solution with hydrogen chloride (HCl).
2. The carbon capture system of clause 1, wherein the CO₂ extraction chamber further generates a NaCl solution when combining the NaHCO₃ solution with the HCl.
3. The carbon capture system of clause 1 or 2, wherein the renewable power source comprises at least one of a wind turbine, a hydropower plant, a geothermal power plant, a pumped storage hydropower unit, a battery, a hydropower plant, or a geothermal power plant.
4. The carbon capture system of any of clauses 1-3, wherein the pumped storage hydropower unit is powered by at least one of a solar power array or a wind turbine.
5. The carbon capture system of any of clauses 1-4, wherein the electrolysis chamber includes a chamber for forming the HCl with the CI and the H generated by the electrolysis chamber.
6. The carbon capture system of any of clauses 1-5, further comprising a receiving chamber that receives seawater and generates the NaCl solution from the seawater.
7. The carbon capture system of any of clauses 1-6, wherein the receiving chamber generates the NaCl solution by filtering the seawater.
8. The carbon capture system of any of clauses 1-7, further comprising a first holding chamber for storing the HCl.
9. The carbon capture system of any of clauses 1-8, wherein the first holding chamber receives the HCl from the electrolysis chamber.
10. The carbon capture system of any of clauses 1-9, further comprising a second holding chamber for storing the aqueous NaOH solution.
11. The carbon capture system of any of clauses 1-10, wherein the second holding chamber receives the aqueous NaOH solution from the electrolysis chamber.
12. The carbon capture system of any of clauses 1-11, wherein the second holding chamber includes a corrosion-resistant container for the aqueous NaOH solution.
13. The carbon capture system of any of clauses 1-12, wherein the electrolysis chamber generates the aqueous NaOH solution via a membrane-based electrolysis process.
14. The carbon capture system of any of clauses 1-13, wherein the mixing chamber includes a sensor for detecting sodium carbonate (NaHCO₃) in the aqueous NaHCO₃ solution.
15. The carbon capture system of any of clauses 1-14, wherein the CI generated by the electrolysis chamber comprises chlorine gas (Cl2), and the H generated by the electrolysis chamber comprises H2 gas.
16. The carbon capture system of any of clauses 1-15, further comprising a CO2 storage chamber that is fluidly coupled to the CO2 extraction chamber.
17. In some embodiments, a method of carbon capture includes: generating chlorine (CI), hydrogen (H), and an aqueous sodium hydroxide (NaOH) solution from a sodium chloride (NaCl) solution using electrical energy from a renewable power source; generating an aqueous sodium bicarbonate (NaHCO3) solution by mixing CO2-containing air and the aqueous NaOH solution; and generating CO2 by combining the aqueous NaHCO3 solution with hydrogen chloride (HCl).
18. The method of clause 17, wherein the aqueous NaOH solution is generated via a membrane-based electrolysis process.
19. The method of clauses 17 or 18, further comprising generating a NaCl solution when combining the NaHCO3 solution with the HCl.
20. The method of any of clauses 17-19, further comprising detecting sodium carbonate (NaHCO₃) in the aqueous NaHCO₃ solution.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A carbon capture system, comprising:
a renewable power source;
an electrolysis chamber that generates chlorine (CI), hydrogen (H), and an aqueous sodium hydroxide (NaOH) solution from a sodium chloride (NaCl) solution using electrical energy from the renewable power source;
a mixing chamber that generates an aqueous sodium bicarbonate (NaHCO₃) solution by mixing CO₂-containing air and the aqueous NaOH solution; and
a CO₂ extraction chamber that generates CO₂ by combining the aqueous NaHCO₃ solution with hydrogen chloride (HCl).

2. The carbon capture system of claim 1, wherein the CO₂ extraction chamber further generates a NaCl solution when combining the NaHCO₃ solution with the HCl.

3. The carbon capture system of claim 1, wherein the renewable power source comprises at least one of a wind turbine, a hydropower plant, a geothermal power plant, a pumped storage hydropower unit, a battery, a hydropower plant, or a geothermal power plant.

4. The carbon capture system of claim 3, wherein the pumped storage hydropower unit is powered by at least one of a solar power array or a wind turbine.

5. The carbon capture system of claim 1, wherein the electrolysis chamber includes a chamber for forming the HCl with the CI and the H generated by the electrolysis chamber.

6. The carbon capture system of claim 1, further comprising a receiving chamber that receives seawater and generates the NaCl solution from the seawater.

7. The carbon capture system of claim 6, wherein the receiving chamber generates the NaCl solution by filtering the seawater.

8. The carbon capture system of claim 1, further comprising a first holding chamber for storing the HCl.

9. The carbon capture system of claim 8, wherein the first holding chamber receives the HCl from the electrolysis chamber.

10. The carbon capture system of claim 1, further comprising a second holding chamber for storing the aqueous NaOH solution.

11. The carbon capture system of claim 10, wherein the second holding chamber receives the aqueous NaOH solution from the electrolysis chamber.

12. The carbon capture system of claim 10, wherein the second holding chamber includes a corrosion-resistant container for the aqueous NaOH solution.

13. The carbon capture system of claim 1, wherein the electrolysis chamber generates the aqueous NaOH solution via a membrane-based electrolysis process.

14. The carbon capture system of claim 1, wherein the mixing chamber includes a sensor for detecting sodium carbonate (NaHCO₃) in the aqueous NaHCO₃ solution.

15. The carbon capture system of claim 1, wherein the Cl generated by the electrolysis chamber comprises chlorine gas (Cl₂), and the H generated by the electrolysis chamber comprises H₂ gas.

16. The carbon capture system of claim 1, further comprising a CO₂ storage chamber that is fluidly coupled to the CO₂ extraction chamber.

17. A method of carbon capture, the method comprising:
generating chlorine (CI), hydrogen (H), and an aqueous sodium hydroxide (NaOH) solution from a sodium chloride (NaCl) solution using electrical energy from a renewable power source;
generating an aqueous sodium bicarbonate (NaHCO₃) solution by mixing CO₂-containing air and the aqueous NaOH solution; and
generating CO₂ by combining the aqueous NaHCO₃ solution with hydrogen chloride (HCl).

18. The method of claim 17, wherein the aqueous NaOH solution is generated via a membrane-based electrolysis process.

19. The method of claim 17, further comprising generating a NaCl solution when combining the NaHCO₃ solution with the HCl.

20. The method of claim 17, further comprising detecting sodium carbonate (NaHCO₃) in the aqueous NaHCO₃ solution.
